(19) United States
(12) Patent Application Publication
(10) Pub. No.: US 2005/0116889 A1
(43) Pub. Date: Jun. 2, 2005

(54) Method of driving plasma display panel and plasma display apparatus

(75) Inventors: Ki-Woong Whang, Seoul (KR); Jae-Sung Kim, Gumi-si (KR)

Correspondence Address: Richard L. Byrne;WEBB ZIESENHEIM LOGSDON ORKIN & HANSON, P.C., 700 Koppers Building, 436 Seventh Avenue, Pittsburgh, PA, 15219-1818, US

(73) Assignee: Ki-Woong Whang, Seoul (KR)

(21) Appl. No.: 10/965,678

(22) Filed: Oct. 14, 2004

(30) Foreign Application Priority Data
Oct. 14, 2003 (KR) 10-2003-0071585

(51) Int. Cl. G09G 3/28

(52) U.S. Cl. 345/60

(57) ABSTRACT

The present invention relates to a method of driving an AC-type plasma display panel and plasma display apparatus, in which differences between scan lines are reduced, so that it is advantageous in high-speed driving and it is stable, in which the power consumption is not concentrated on a specific period, so that a power circuit is easily designed, in which the degradation of phosphor and degradation of image quality, such as an afterimage, due to an increase in the temperature of a panel can be prevented, and in which an ability to display low gray scales is improved and pseudo contour noise is easily reduced. In the plasma display panel driving method, the image information has one or more frames each divided into one or more sub-fields used to display gray scales through combinations of the sub-fields. The sub-fields are each divided into one or more driving units T each having an address period, a sustain period and an erase period that are temporally separated. In the plasma display panel driving method, data for a corresponding sub-field is written during an address period in a first one of the driving units T constituting the sub-field. Data for the corresponding sub-field is erased during an erase period in a last one of the driving units T constituting the sub-field.

### BACKGROUND OF THE INVENTION

1. Field of the Invention

The present invention relates, in general, to a method of driving an alternating current-type plasma display panel and plasma display apparatus, more particularly, to a method of driving an alternating current-type plasma display panel and plasma display apparatus, which is capable of solving not only problems, such as difficulty in high-speed driving, and the concentration of the power consumption and the increase of the temperature of the panel due to the concentration of sustain discharges, which a conventional address display period-separated driving scheme has, but also problems, such as the complexity of a drive circuit and the decrease of a contrast ratio due to a strong discharge occurring during a reset period, which cannot be solved even in an address-while-display driving scheme proposed as a substitute for the address display period-separated driving scheme.

2. Description of the Related Art

FIG. 1 is a perspective view showing the construction of an Alternating Current (AC)-type Plasma Display Panel (PDP). As shown in FIG. 1, the AC-type PDP includes an upper panel 1 composed of a plurality of scan electrodes Y and sustain electrodes X arranged in parallel with each other on a glass plate, an upper dielectric layer 8 covering the electrodes Y and X, and a protection layer 9 formed beneath the upper dielectric layer 8. Further, the PDP includes a lower panel 2 composed of a plurality of address electrodes A formed to be orthogonal with both the scan electrodes Y and the sustain electrodes X, a lower dielectric layer 5 covering the address electrodes A to form a reflecting layer, barrier ribs 3 dividing respective cells from each other, and a phosphor layer 4 arranged in parallel with the address electrodes A and applied to the side and bottom surfaces of the barrier ribs 3 so as to emit visible rays. After a vacuum is applied to a space between the upper and lower panels 1 and 2, a discharge space between the upper and lower panels 1 and 2 is filled with two-types or three-types of inert gas, including Xe gas. A single discharge cell is formed at each of the locations where the scan electrodes Y and the sustain electrodes X of the upper panel 1 and the address electrodes A of the lower panel 2 intersect. For the display of a color image, three cells exhibiting red, green and blue are combined into a single pixel.

In order to drive such an AC-type PDP, an Address Display period-Separated (ADS) driving scheme schematically shown in FIG. 2 (refer to Korean Pat. No. 88852 or U.S. Pat. No. 5,541,618) has been most generally used in the prior art. In the ADS driving scheme, eight sub-fields having different brightnesses are provided in one TV field (=16.7 ms) for displaying an image so as to display 256 gray scales. Each of the sub-fields is composed of a reset period, an address period (or write period), and a sustain period. That is, the sub-fields have the lengths of sustain periods corresponding to 2⁰, 2¹, 2², 2³, 2⁴, 2⁵, 2⁶ and 2⁷, respectively. Therefore, 256 (=28) gray scales can be displayed through the combinations of these sub-fields. As shown in FIG. 2, in the ADS driving scheme, a reset period, an address period and a sustain period are simultaneously performed with respect to all scan lines on a panel.

FIGS. 3a and 3b show an operation for one sub-field in the ADS driving scheme in detail. First, a reset period 100, used to equalize the states of the wall charges of all cells, performs the function of allowing subsequent address discharges to be generated under the same initial conditions by equalizing the initial conditions of all cells, besides the function of erasing previous image information. In order to display an image based on an image signal, an address period 200 performs the function of generating a discharge between a scan electrode Y and an address electrode A arranged to be orthogonal with each other in a corresponding cell and forming a positive wall charge on the scan electrode Y and a negative wall charge on the address electrode A so as to select cells to be turned on or off during a subsequent sustain period 300. The sustain period 300 performs the function of applying a sustain voltage lower than a discharge start voltage between the scan electrode Y and the sustain electrode X so as to sustain a discharge in only the cell turned on during the address period 200, thus continuing the sustain discharge in the cell in which a wall charge is formed through the discharge between the scan electrode Y and the address electrode A during the address period 200.

In such an ADS driving operation, since address periods are completely separated from the sustain periods with respect to all scan electrodes, the period taken to perform addressing after reset, and the period taken to perform the sustain period after the addressing vary with scan electrodes. That is, the point when the addressing (writing) of a scan electrode corresponding to the last scan line of the panel is performed is the point after a relatively long period elapses from the termination of the reset period. Therefore, an address discharge for the last scan line occurs under-conditions considerably different from conditions where the addressing of a scan electrode corresponding to a first scan line is performed. Therefore, the ADS driving scheme is problematic in that, since the address discharge characteristics is too much dependent on scan timing, this scheme is not suitable for high-speed driving, and since the times taken to transition from an address discharge to a sustain discharge are not uniform according to scan electrodes, a first sustain discharge cannot uniformly occur.

Further, the above ADS driving scheme is problematic in that, since sustain discharges are simultaneously performed in all cells, the power consumption is concentrated on a specific period, so that high instantaneous power consumption should be taken into consideration at the time of designing a power circuit. Further, the temperature of a panel increases due to the sustain discharges concentrated on a specific period, thus causing the degradation of phosphor and the degradation of image quality, such as an afterimage.

For conventional technology to solve the above problems, there has been proposed an Address While Display (AWD, an address discharge during a sustain period) driving scheme in which an address period and a sustain period coexist, as shown in FIG. 4. However, if this AWD driving scheme is applied without change, a driving circuit is complicated, and background light becomes higher due to a strong discharge during a reset period to deteriorate a contrast ratio, thus causing the degradation of image quality. Therefore, this AWD driving scheme is not currently applied to actual products.

### SUMMARY OF THE INVENTION

Accordingly, the present invention has been made keeping in mind the above problems occurring in the prior art, and the present invention proposes a method of driving a plasma display panel and plasma display apparatus, which can display required gray scales through the combinations of basic driving units T each composed of only an address period, a sustain period and an erase period without a reset period, unlike conventional PDP driving schemes, thus improving the deterioration of contrast ratio due to background light that is one of the problems of the conventional driving schemes.

In the present invention, one TV field is divided into a plurality of basic driving units T (for example, 255 basic driving units as shown in FIG. 5), and a set of one or more driving units constitutes one sub-field. Further, in the present invention, basic driving units T, which belong to the same sub-field and correspond to each other in terms of a sequence, are arranged in different periods for respective scan electrodes, respectively (for example, sequentially across scan lines). Further, respective sub-fields are arranged to allow the points when the addressing (writing) of corresponding sub-fields according to scan electrodes occurs to differ (for example, as shown in FIG. 6), thus enabling the address period of an arbitrary scan electrode to be located during the sustain period of other scan electrodes. With this operation, the present invention attempts to reduce an increase in the instantaneous power consumption due to the concentration of sustain discharges on a specific period, and the degradation of phosphor and the characteristics of an afterimage due to an increase in the temperature of a panel, which occurred in a conventional ADS driving scheme.

Further, unlike the conventional ADS driving scheme, the present invention establishes an address period with respect to each of basic driving units T and then reduces the address period. As a result, differences in time intervals between the termination of erase operations to the occurrence of address operations are reduced according to scan electrodes, thus facilitating high-speed driving. Further, time intervals between the termination of address discharges and the occurrence of sustain discharges are reduced, thus realizing a stable transition to the sustain discharges.

Further, the driving method and plasma display apparatus of the present invention attempts to arbitrarily change the arrangement sequence of sub-fields according to respective scan lines, unlike the conventional ADS driving scheme, so that there is an advantage in the elimination of “moving image pseudo contour noise”, which has been pointed out as a problem at the time of displaying moving images in the prior art.

Further, the driving method and plasma display apparatus of the present invention attempts to add a sub-field by adding only a basic driving unit T, thus easily obtaining a high-quality image, such as by implementing a sub-field corresponding to a weight lower than one bit (for example, 0.5 bit) so as to improve an ability to display low gray scales.

Further, a conventional AWD driving scheme is problematic in that, since driving waveforms differ according to scan lines, a driving circuit becomes complicated, while the present invention is advantageous in that, since it attempts to use the same driving waveform according to scan or sustain electrodes (for example, as shown in FIG. 7), a driving circuit can be implemented with a simple circuit.

In accordance with a first aspect of the present invention, there is provided a method of driving an Alternating Current (AC)-type plasma display panel to display predetermined image information on the plasma display panel having a plurality of scan electrodes, a plurality of sustain electrodes corresponding to the scan electrodes, a plurality of address electrodes arranged to be orthogonal with the scan electrodes, and a plurality of discharge cells formed on respective locations where the scan electrodes and the address electrodes are orthogonal with each other, the image information having one or more frames each divided into one or more sub-fields used to display gray scales through combinations of the sub-fields, the sub-fields each being divided into one or more driving units T each having an address period, a sustain period and an erase period that are temporally separated, comprising writing data for a corresponding sub-field during an address period in a first one of the driving units T constituting the sub-field; and erasing data for the corresponding sub-field during an erase period in a last one of the driving units T constituting the sub-field.

In accordance with a second aspect of the present invention, there is provided a method of driving an Alternating Current (AC)-type plasma display panel, wherein the image information has one or more frames each divided into one or more driving units T, the driving units each having an address period, a sustain period and an erase period that are temporally separated; and the erase period is constructed in such a way that a certain waveform to generate an erase discharge is applied to the scan electrodes during the erase period, the waveform having one or more periods during which multiple narrow pulses are repeated.

In accordance with a third aspect of the present invention, there is provided an Alternating Current (AC)-type plasma display apparatus to display predetermined image information on an AC-type plasma display panel, the image information having one or more frames each divided into one or more sub-fields used to display gray scales through combinations of the sub-fields, the sub-fields each being divided into one or more driving units T each having an address period, a sustain period and an erase period that are temporally separated, comprising driving means writing data for a corresponding sub-field during an address period in a first one of the driving units T constituting the sub-field; and driving means erasing data for the corresponding sub-field during an erase period in a last one of the driving units T constituting the sub-field.

Preferably, the scan electrodes may be constructed so that a start point of one sub-field of one scan electrode is different from those of corresponding sub-fields of one or more adjacent scan electrodes.

Preferably; the scan electrodes may be constructed so that a start time of an m-th sub-field of an n-th scan electrode of the panel has a time difference of one driving unit T with respect to a start time of an m-th sub-field of an n+1-th scan electrode.

Preferably, the address period of each of the driving units T may be defined by a period equal to or longer than a time obtained by multiplying the total number of sub-fields by a width of a unit address pulse, the sustain period may be constructed in such a way that sustain pulses are alternatively applied to the scan and sustain electrodes during the sustain period, and the erase period may be constructed in such a way that a certain waveform to generate an erase discharge is applied to the scan electrodes during the erase period.

Preferably, the waveform applied to the scan electrodes for an erase discharge may have one or more periods during which multiple narrow pulses are repeated.

Preferably, each of the narrow pulses may have a width of 300 ns or below.

Preferably, the waveform applied to the scan electrodes for an erase discharge may be formed so that a period during which a pulse having a negative polarity is applied is additionally inserted into periods during which multiple narrow pulses are repeated.

Preferably, the multiple narrow pulses are overlapped with a ramp waveform increasing with the elapse of time and applied.

Preferably, the sustain period of each of the driving units T constituting the sub-field may be constructed so that one or more second address periods are additionally inserted into the sustain period so as to display a gray scale lower than a gray scale that can be displayed by a sub-field having a minimum time length.

Preferably, the sub-fields constituting one frame may be arranged in different sequences according to the scan lines.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view showing an example of the construction of an AC-type Plasma Display Panel (PDP) applied to the present invention;

FIG. 2 illustrates an example of time division applied to a conventional ADS driving scheme;

FIGS. 3a and 3b illustrate an operation performed for one sub-field in detail in the conventional ADS driving scheme;

FIG. 4 illustrates an example of time division applied to a conventional AWD driving scheme;

FIG. 5 illustrates an example of time division applied to a driving method according to an embodiment of the present invention;

FIG. 6 is a view showing the configuration of a basic driving unit T and the arrangement of sub-fields in the time division of FIG. 5;

FIG. 7 is a view showing an example of the arrangement of driving waveforms according to an embodiment of the present invention;

FIG. 8 is an enlarged view of the basic driving unit T of the driving waveforms of FIG. 7;

FIG. 9 is a view showing an example of driving waveforms to improve an ability to display low gray scales according to another embodiment of the present invention;

FIG. 10 is an enlarged view of the basic driving unit T of the driving waveforms of FIG. 9;

FIG. 11 is a view showing an example of an erase waveform used in the driving method of the present invention, which illustrates the principle of erasing multiple narrow pulses;

FIG. 12 is a view showing an example in which the arrangement of sub-fields is changed according to respective scan lines as an embodiment for the reduction of moving image pseudo contour noise according to the present invention;

FIG. 13a illustrates the operating range of a drive voltage obtained when the driving waveforms of the present invention are applied to a typical panel, and FIG. 13b illustrates the operating range of a drive voltage obtained when the driving waveforms of the present invention are applied to a panel having a magnesium oxide coated phosphor layer;

FIG. 14 is a view showing another example of an erase waveform applicable to the driving method of the present invention;

FIG. 15 illustrates the configuration of a basic driving unit T obtained when the erase waveform of FIG. 14 is applied;

FIG. 16 is a view showing another example of driving waveforms of the present invention to improve an ability to display low gray scales;

FIG. 17 is a view showing an example of the configuration of a basic driving unit when the number of sub-fields is m and the number of scan lines is greater than 2^{m}−1; and

FIGS. 18 and 19 are views showing other examples of an erase waveform applicable to the driving method of the present invention.

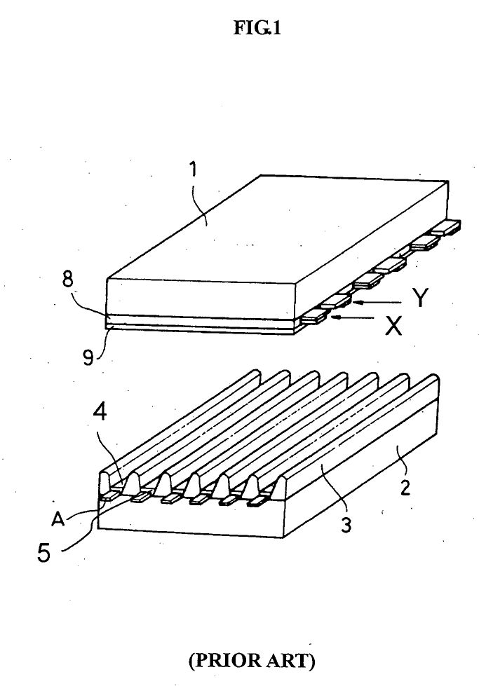

### DESCRIPTION OF THE PREFERRED EMBODIMENTS

Hereinafter, embodiments of the present invention will be described in detail with reference to the attached drawings.

The present invention can be applied to display panels for Video Graphics Array (VGA)-class (typically 480 horizontal lines), Extended Graphics Array (XGA)-class (typically, 768 horizontal lines), High Definition (HD)-class (typically, 1080 horizontal lines) TVs or monitors, or to other specially designed small, middle or large-sized display panels, with modification being made depending on the detailed specifications thereof or the number of gray scales to display. Hereinafter, for ease of understanding of the technical spirit of the present invention, the present invention will be illustratively described on the basis of an embodiment to which the present invention is applied to the display of 256 gray scales.

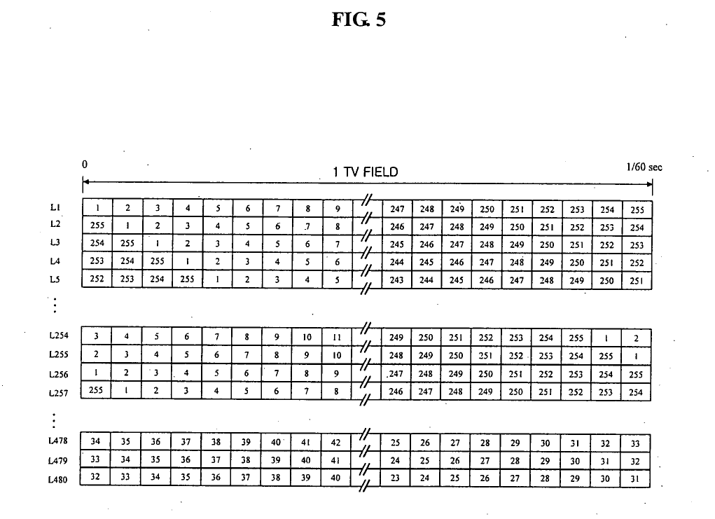

FIG. 5 shows an example in which one TV field is divided into respective driving units T so as to apply the present invention to a case where 256 gray scales are to be displayed in a VGA-class panel having 480 scan lines. The display of 256 gray scales is generally implemented through the combinations of 8 sub-fields having the lengths of light emission periods corresponding to 2⁰, 2¹, 2², 2³, 2⁴, 2⁵, 2⁶, and 2⁷, respectively. In this case, 8 bit image data are required. However, since it is possible to display 2ⁿ gray scales using typical n bit data, the present invention is not limited to the embodiment of FIG. 5.

As shown in FIG. 5, one. TV field (typically 16.7 ms) is divided into basic driving units T each composed of an address period, a sustain period and an erase period. In this case, the basic driving units T can be designed to have the same length as shown in FIG. 5, or designed to have different lengths if necessary. Further, even in the display of 256 gray scales, one TV field is not always divided into 255 units as shown in FIG. 5. FIG. 5 shows only a modification of the present invention in which one or more basic driving units T each composed of an address period, a sustain period and an erase period constitute a sub-field.

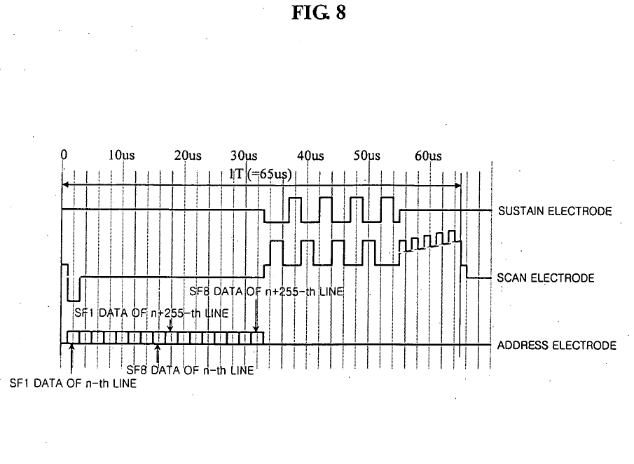

For ease of understanding of the present invention, FIG. 5 illustrates a case where one TV field is divided into 255 driving units having the same length. In this case, required sub-fields are formed by combining respective driving units. For example, a first sub-field 2⁰ having lowest brightness may be composed of one basic driving unit T, a second sub-field 2¹ may be composed of two basic driving units T, and a third sub-field 2² may be composed of four basic driving units T. In this way, in the case of the display of 256 gray scales, a sub-field 2⁷ having a maximum size may be composed of 128 basic driving units T. In this case, as shown in FIG. 5, 256 gray scales can be displayed using a total of 255 basic driving units in one TV field. Accordingly, one driving unit T can be constructed to have a period of approximately 65 μs or below, as shown in FIGS. 5 and 8.

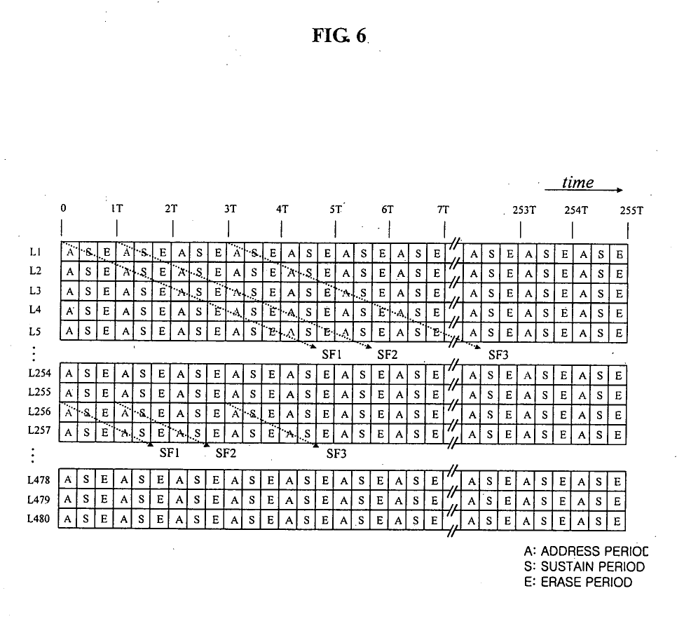

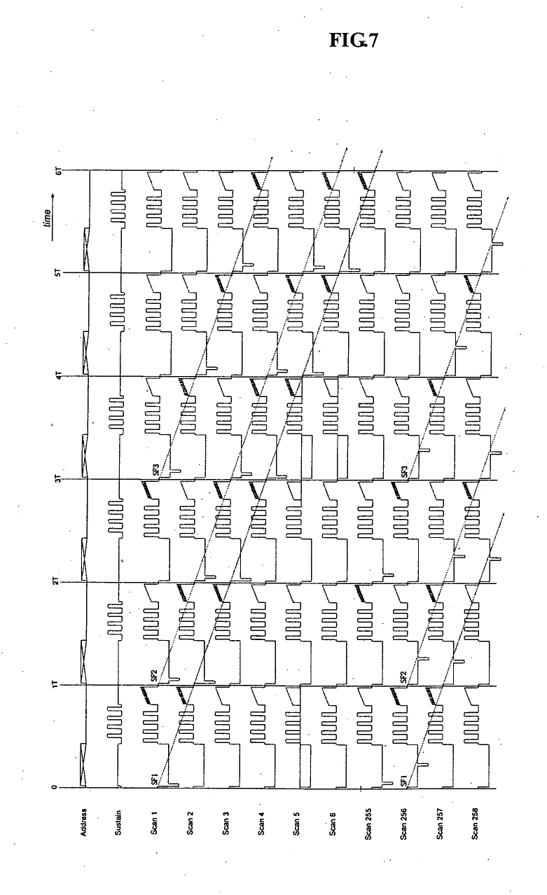

FIG. 6 illustrates an example of the arrangement of an address period A, a sustain period S and an erase period E in each of the driving units T, in which respective sub-fields are sequentially arranged so that the start points of neighboring sub-fields have a difference of one driving unit T with respect to respective scan lines. The arrangement of sub-fields with respect to respective scan lines can be variously modified and designed. That is, those skilled in the art will appreciate that any modifications are possible in such a way that, for example, the start points of neighboring sub-fields with respect to scan lines may have a difference of two or three driving units, or the sequential arrangement of the sub-fields may be changed.

If the arrangement of the sub-fields of FIG. 6, is employed, identification numbers 1, 2, . . . , 256 marked on the respective driving units T indicated in FIG. 5 are set so that the same identification number in the respective scan lines indicates a driving unit, which belongs to the same sub-field and is located at the same position in the sub-field. That is, FIG. 5 shows an example in which 1 corresponds to a first sub-field, 2 and 3 correspond to a second sub-field, 4 to 7 correspond to a third sub-field, 8 to 15 correspond to a fourth sub-field, 16 to 31 correspond to a fifth sub-field, 32 to 63 correspond to a sixth sub-field, 64 to 127 correspond to a seventh sub-field, and 128 to 255 correspond to an eighth sub-field.

FIG. 7 shows scan waveforms applied to respective scan lines according to driving units in the case where the arrangement of sub-fields and the division of driving units of FIGS. 5 and 6 are satisfied. In this embodiment, the addressing of data for a corresponding sub-field is performed during an address period of a first driving unit in each of the sub-fields, as shown in FIG. 7. During the address period of other driving units constituting the sub-field, only an address period exists, but an actual address operation is not performed, because the addressing of data for the corresponding sub-field is not required (at this time, the address operation for a part of other scan lines of the panel is performed). Further, during the erase period of the last driving unit in each of the sub-fields, the data of a corresponding sub-field are erased to allow a next sub-field to be performed. Similarly, during the erase periods of driving units other than the last driving unit, only erase periods exist, but actual erasing is not performed, because the image data of the corresponding sub-field written in the above first driving unit should not be erased. With this construction, the address period of an arbitrary scan line is located during the sustain periods of other scan lines.

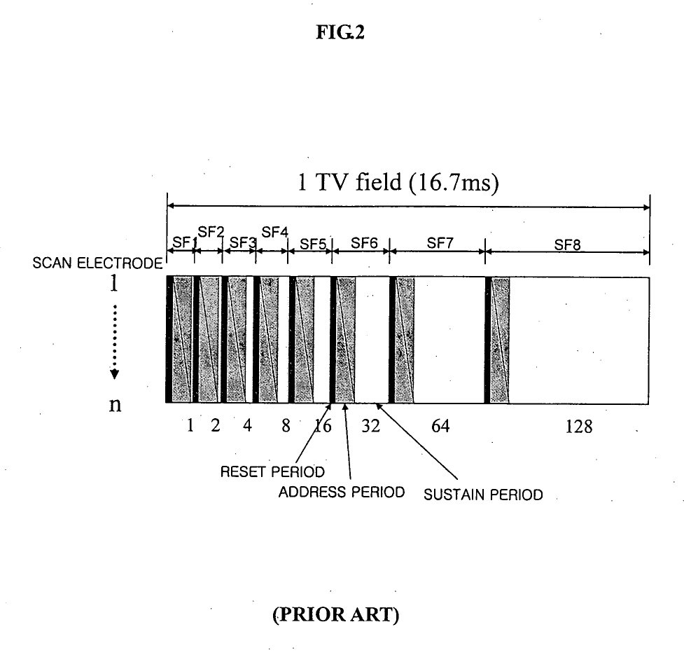

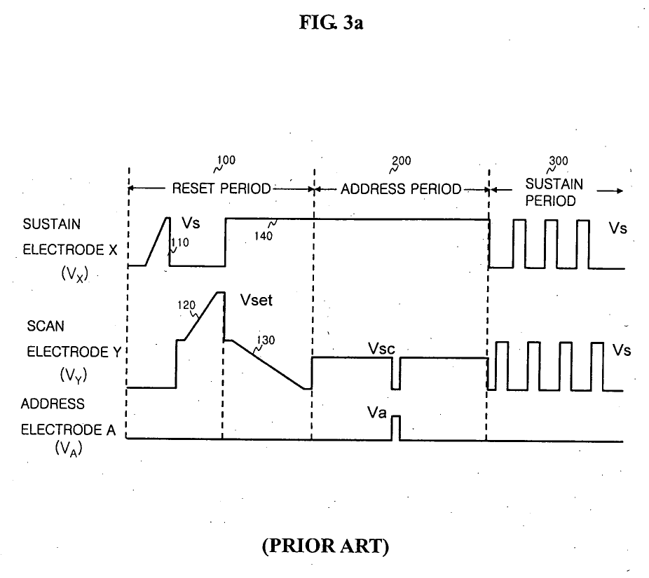

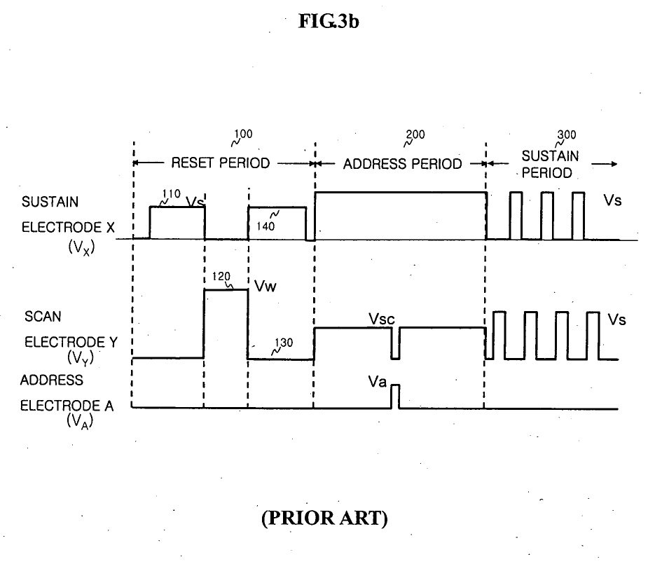

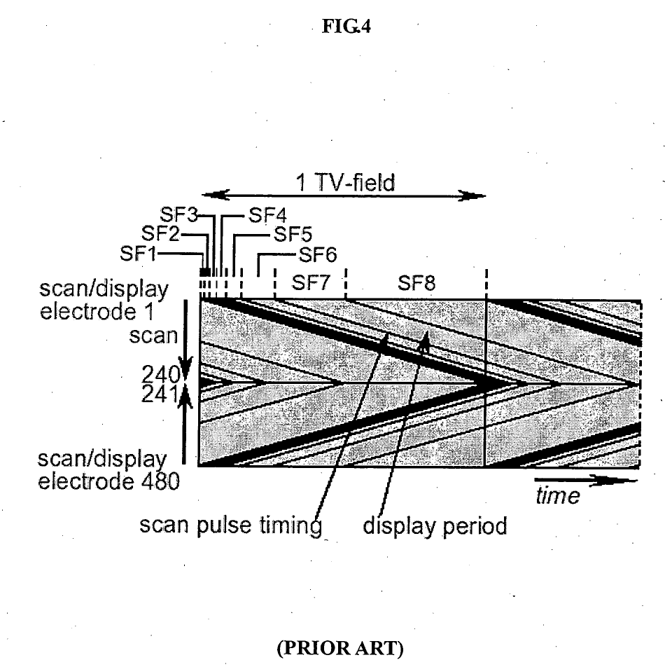

In a conventional driving scheme shown in FIG. 2, sustain discharges are simultaneously performed with respect to all scan lines after reset and address operations for all scan lines have terminated, so that sustain discharges are concentrated on a specific period, thus causing an increase in the temperature of the panel due to the concentrated sustain discharges, the degradation of phosphor caused thereby, and an afterimage problem in which an image on a previous screen still remains. However, in the driving method and plasma display apparatus of the present invention, one TV field is composed of a plurality of basic driving units T, each having an address period, a sustain period and an erase period. Therefore, the present invention is constructed to uniformly distribute periods corresponding to sustain discharges over one TV field, thus preventing the problems due to the concentration of the sustain discharges.

The driving waveform in each of the driving units T shown in FIG. 7 is depicted in detail in FIG. 8. The address period of the driving unit T is determined depending on the number of bits of gray scales to display (for example, 8 bits in case of 256 gray scales) and the size of a panel. As shown in FIG. 8, in order to display 256 gray scales in a VGA-class panel, it is sufficient to ensure an address period equal to or longer than the period during which a total of 16 unit address pulses can be arranged. Therefore, in the present invention, since the address period is not long, an address discharge can be performed at a speed higher than that of a conventional scheme, and differences between scan lines due to the differences in time intervals between address periods and sustain periods can be reduced.

Further, it is preferable that a maximum number of pulses are applied so as to improve maximum luminance during a sustain period (for example, about 1020 pulses can be applied to each of electrodes in one TV field if four pulses are applied to one electrode).

Further, as shown in FIGS. 8 and 11, during the erase period, various erase pulses can be used to perform uniform erase operations within short periods with respect to cells turned on. For example, a scheme of applying single erase pulse, which was frequently used in the prior art, can be used; however, a scheme of continuously applying a plurality of narrow pulses, designed by the present inventor (refer to Korean Pat. Appl. No. 2002-76717) can be used to more efficiently control wall charges and perform uniform erase operations within a short period.

With this driving scheme, the waveforms applied to respective scan electrodes during the address period differ according to scan lines, as shown in FIG. 7, and both address operations and sustain periods differ according to the scan electrodes. As a result, during the sustain operation of one scan electrode, the write operation (address operation) of another scan electrode is performed, as shown in FIG. 7. Further, in the driving method of the present invention, an address discharge, a sustain discharge and an erase discharge are performed in a basic driving unit T having a short time length (for example, about 65 us) as shown in FIG. 8, unlike conventional schemes, such as the ADS driving scheme. Therefore, the time interval from the termination of an erase operation to the occurrence of an address period is short, so that the address discharge can be performed under relatively uniform conditions at high speeds. Similarly, the period taken to transition to a sustain discharge after the termination of an address discharge is short, thus realizing a stable transition from the address discharge to the sustain discharge.

FIG. 11 shows an erase operation using multiple narrow pulses of the present invention.

Generally, a PDP is composed of millions of cells, the electrical characteristics of which are not identical with each other and have slight differences therebetween. In other words, the respective cells are slightly different in discharge start voltage V_{b} and wall voltage V_{w} formed due to the sustain discharge. Therefore, it is difficult to obtain uniform and stable panel characteristics using only a conventional single pulse-type erase waveform adapted to apply a single erase pulse and perform an erase operation with respect to all cells. For another conventional technology of solving this difficulty, a scheme of applying a ramp biased erase pulse has been proposed. In this case, there is a problem in that the time required for erasing is long, perfect erasing is not performed, and a part of wall discharges still remain.

For an erase pulse using multiple narrow pulses of the present invention proposed to solve the problem, a voltage Vgap applied into cells is varied with time at the point when the erase pulse is applied, as shown in FIG. 11. Therefore, even though formed wall voltages and discharge start voltages differ according to cells, a stable erase operation can be performed within a short period. That is, an erase discharge starts at the point when the voltage Vgap applied to each of the cells satisfies the following Equation [1], thus performing a stable erase operation even though there are differences in discharge start voltage and wall charge between respective cells.
Vw+Ve=Vgap>Vb [1]

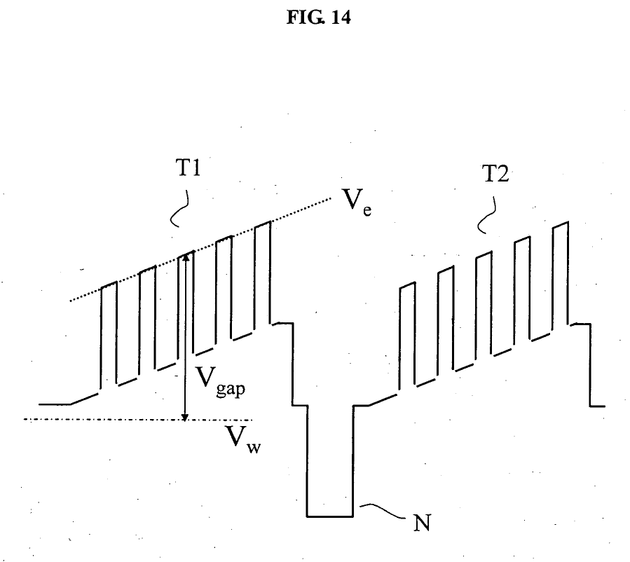

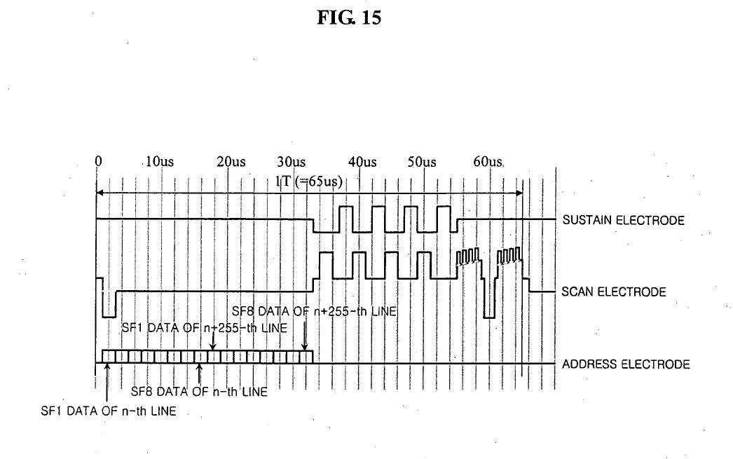

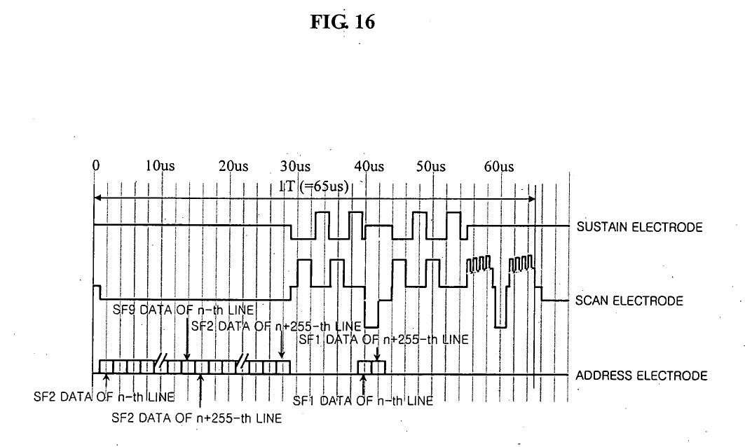

Further, for another example of the erase waveform of the present invention, the erase waveform is configured in such a way that a pulse N having a negative polarity is applied to a scan electrode after an erase pulse composed of multiple narrow pulses, and multiple narrow pulses are applied to the scan electrode once more, as shown in FIG. 14. In a first period T1 of multiple narrow pulses, an erase operation is performed between scan and sustain electrodes. In the subsequent negative scan pulse N, discharges are simultaneously performed between the scan electrode Y, the sustain electrode X and the address electrode A to share wall charges, thus performing an erase operation. The erase waveform can be configured so that, in a second period T2 of multiple narrow pulses, wall charges remaining between the scan and address electrodes are erased once more, thus performing a more stable erase operation. FIGS. 15 and 16 illustrate a driving method according other embodiments of the present invention, which show examples of a basic driving unit T to which the erase waveform of FIG. 14 is applied. The erase waveforms of FIGS. 14, 15 and 16 show cases where multiple narrow pulses overlap with a ramp waveform biased at a predetermined slant. In this case, it was observed by the present inventor that the slant can be variously adjusted or optimized, and stable erase characteristics can be obtained compared to the prior art using a single erase pulse, even though the multiple narrow pulses are applied without being overlapped with a ramp waveform.

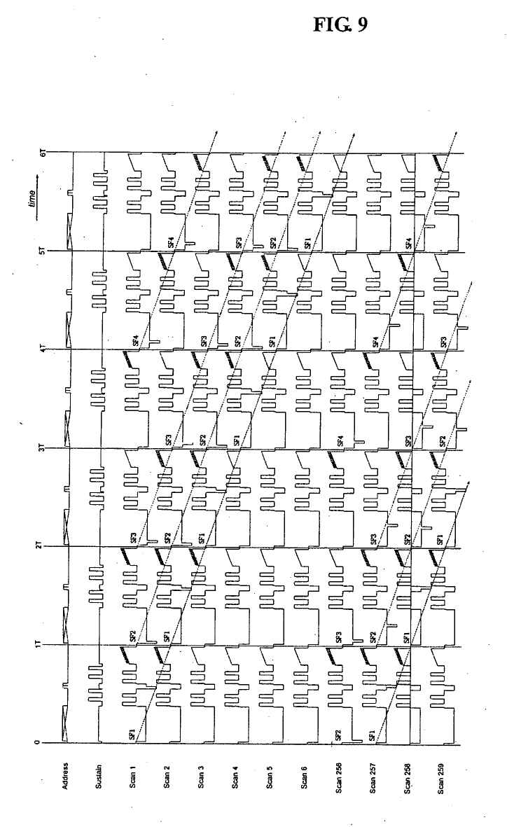

FIG. 9 illustrates the driving waveform according to another embodiment of the present invention. Generally, a PDP is constructed to use the combinations of sub-fields having different brightnesses for the display of gray scales, as shown in FIG. 2. Further, the PDP is constructed to apply a plurality of sustain pulses, the number of which is greater than a certain number (for example, a minimum of four pulses at the time of displaying 256 gray scales using 8 bits), to improve peak luminance, even in the case of a sub-field corresponding to a minimum bit. Further, the PDP is constructed to apply a sufficient number of pulses (for example, about 1000 pulses (4*255=1020) are applied when 256 gray scales are displayed using 8 bits) so as to obtain sufficient luminance at the time of exhibiting maximum brightness.

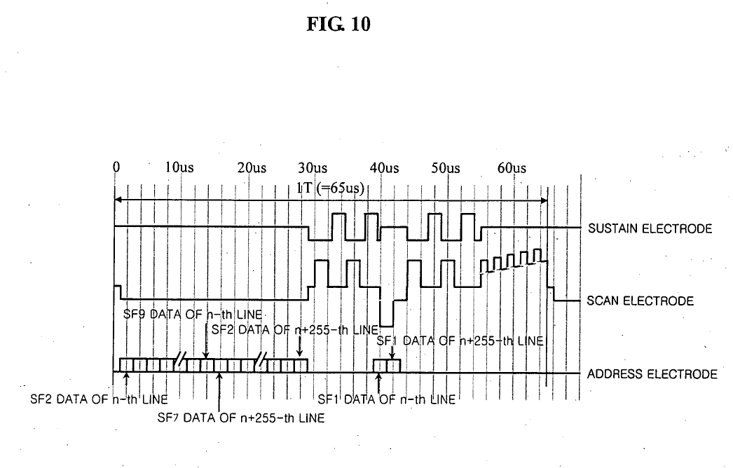

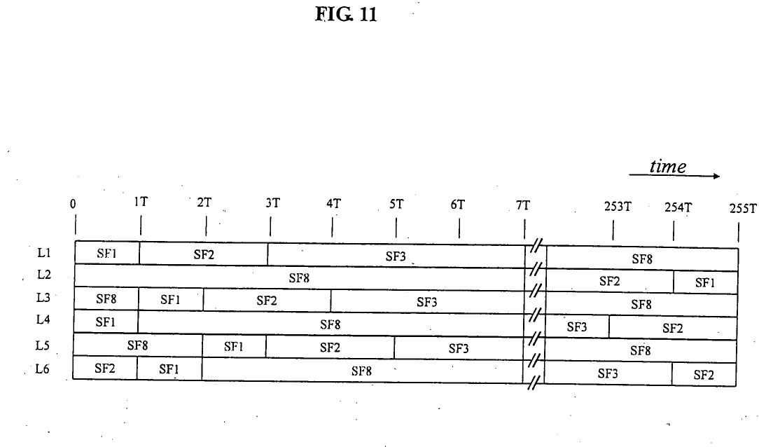

However, in this case, there is a problem in that, since it is impossible to display a low gray scale using four or fewer pulses, luminance gradations are wider in a low gray scale region, so that the display of the low gray scale is not smooth. In order to solve this problem, a signal processing technique, such as error distribution and dithering, is used, but there are limitations in the display of the low gray scale using only the signal processing technique. However, in the driving method of the present invention, a basic driving unit T is modified, so that a sub-field exhibiting brightness lower than 1 bit corresponding to a minimum sub-field can be implemented, thus providing smoother feeling at the time of displaying a low gray scale. As shown in FIG. 9, in the driving method of the present invention, a period for an address discharge is additionally located during the sustain period of the basic driving unit, so that the representation of bits lower than 1 bit (for example, if necessary, 0.25, 0.5, 0.75 bit, etc.) can be very simply implemented. For example, an address discharge is performed during a sustain discharge in a sub-field corresponding to 0.5 bit, as shown in FIG. 10, and thus, the brightness corresponding to a half of a typical sub-field corresponding to 1 bit is exhibited.

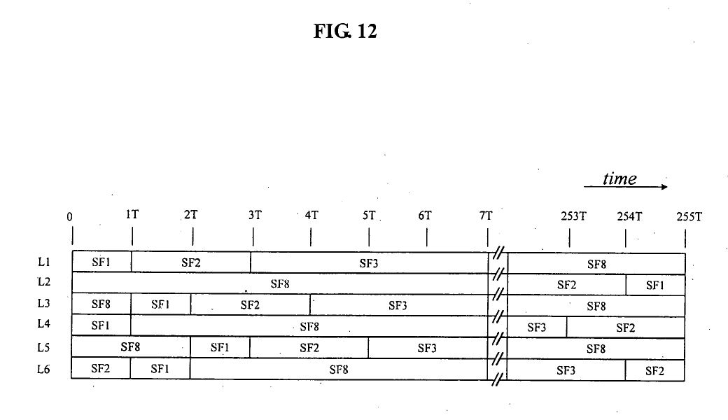

Generally, in the schemes of displaying gray scales through the combinations of sub-fields as in the case of a PDP, pseudo contour noise is inevitably generated at the time of displaying a moving image. In order to reduce the pseudo contour noise, there is generally used a method of changing the arrangement sequence of sub-fields and dividing a sub-field corresponding to the highest brightness into several sub-fields. However, when this modification is applied to the conventional ADS driving scheme or the like so as to reduce the pseudo contour noise, a fatal problem occurs in that a reset period and an address period are added in proportion to the increased number of sub-fields, and a sustain period is relatively reduced, thus decreasing entire luminance. However, in the driving method of the present invention, sub-fields may be arranged in different sequences according to scan lines, as shown in FIG. 12. Further, since the present invention basically employs a scheme of differently driving the panel according to scan lines, such rearrangement of sub-fields incurs no problems, so that the pseudo contour noise can be greatly reduced through the application of the rearrangement of sub-fields.

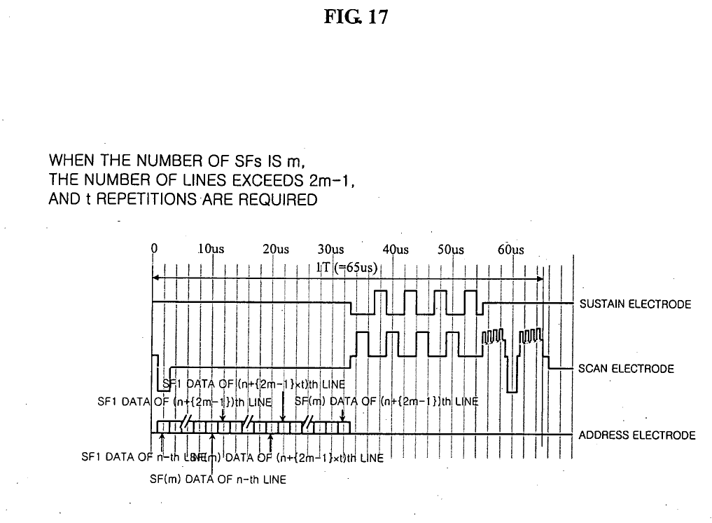

Hereinbefore, for a detailed embodiment to which the driving method of the present invention is applied, a case where 256 gray scales are displayed using 8 bit image data with respect to a VGA-class panel with 480 scan lines is described. However, it is clear that the driving method of the present invention can be applied regardless of the number of bits of image data and the specifications of a panel. FIG. 17 illustrates the configuration of a basic driving unit T in the case where m bit image data (that is, when m sub-fields are used) are used and the number of scan lines exceeds 2^{m}−1. In this case, as shown in FIG. 5, even though corresponding basic driving units T are sequentially arranged according to scan lines (for example, the basic driving units of 1 to 255 are sequentially arranged), basic driving units T having the same numbers repeatedly appear in the case of scan lines, the number of which exceeds 2 ^{m}−1. FIG. 17 shows the configuration of a basic driving unit obtained in this case, in which the number of image data bits to be input during an address period is increased, so that the address period should be obtained in consideration of the number of image data bits. When a panel having a great number of scan lines is driven, the driving method of the present invention is more advantageous than the conventional scheme of FIG. 2 in which address operations are simultaneously performed with respect to all scan lines, because differences in time intervals between erase and address periods are greatly reduced and differences in time intervals between address and sustain periods are also greatly reduced even though a sufficient address period should be obtained in a basic driving unit. Therefore, the driving method of the present invention has a great advantage in a large-sized panel with high image quality.

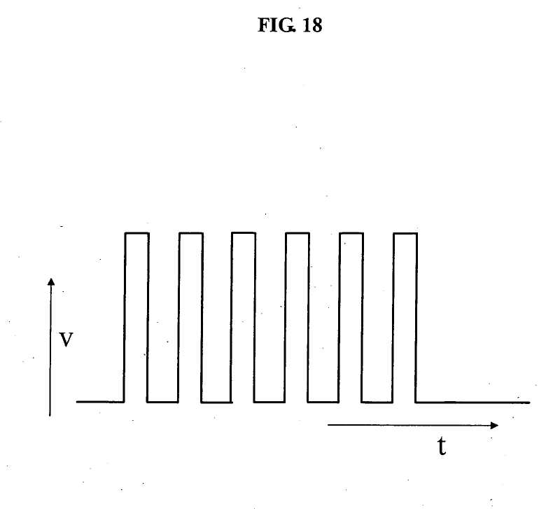

FIG. 18 illustrates another example of a multiple narrow pulse waveform usable for an erase operation in the driving method of the present invention. Unlike the example of FIG. 11, FIG. 18 shows a modified waveform in which two or more narrow pulses are only repeatedly applied, but they are not overlapped with a bias voltage. This waveform can also be used for an erase operation to implement the driving method of the present invention.

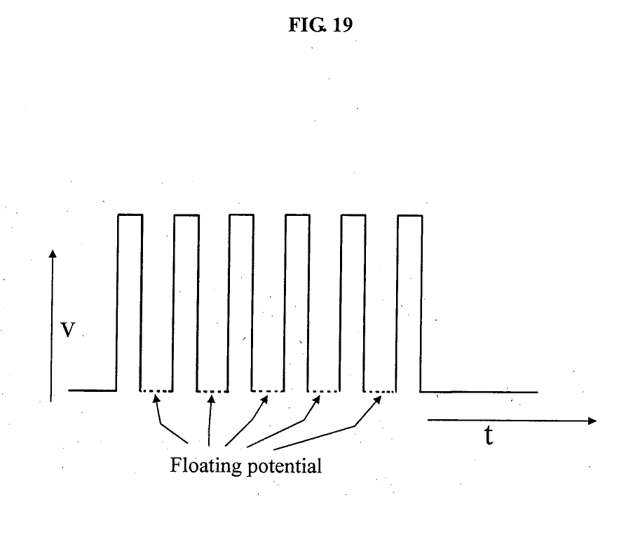

FIG. 19 illustrates a further example of a multiple narrow pulse waveform usable for an erase operation in the driving method of the present invention. Unlike the example of FIG. 18 in which the potential of an electrode is maintained at a certain base potential, the example of FIG. 19 is characterized in that a floating potential is applied to an electrode during time intervals between narrow pulses, which means that the electrode is isolated from an external circuit and the potential of the electrode is not defined during the time intervals. This driving operation can be easily achieved by, for example, a method of turning off a switching element of a driving circuit and opening a path between the external circuit and the electrode, after a single narrow pulse is applied, and the potential thereof is increased, maintained at its peak potential for a certain period, and then decreased. Besides the above examples described above, various modifications are possible, but they are only modifications in design, which belong to the categories of the technical spirit of the present invention in that two or more narrow pulses are repeatedly applied to perform a stable erase operation.

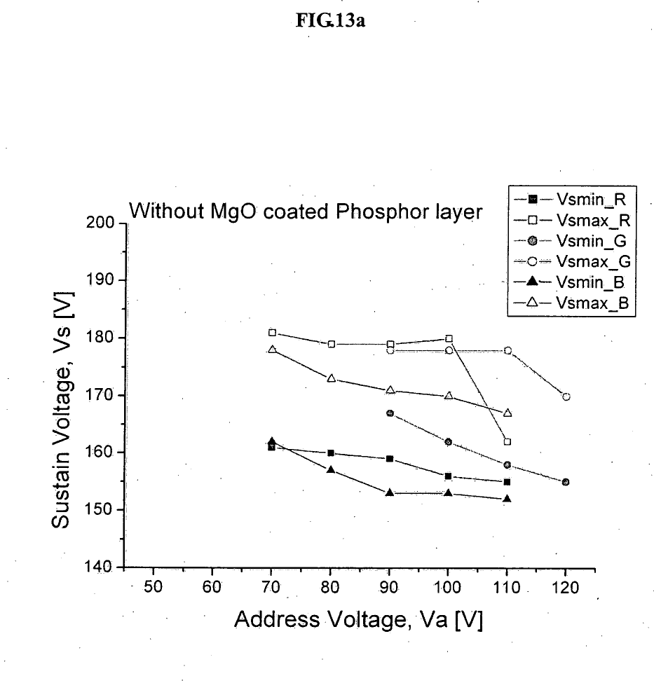

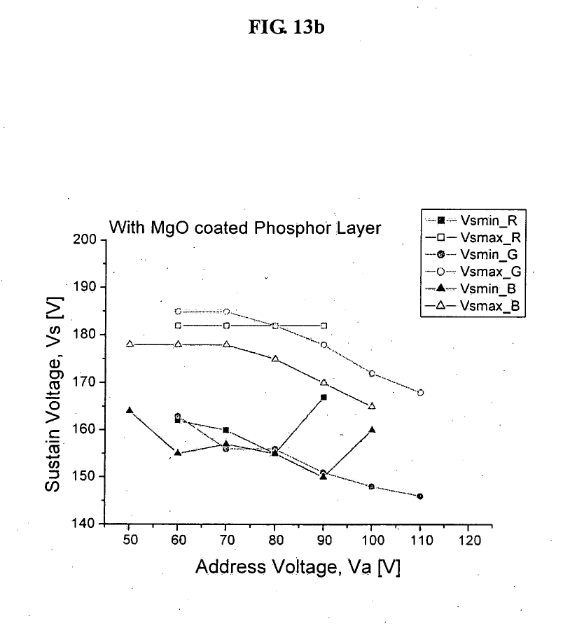

When the driving waveform of the present invention is used, a reset pulse is not applied before an address discharge, unlike conventional driving schemes, so that background light is not generated and a high-quality image with an excellent contrast ratio is obtained. However, consideration needs to be given to compensate for differences between R, G, and B color cells that may occur, as the reset pulse is not used. For this consideration, any schemes designed to compensate for the differences between R, G and B color cells can be utilized, in particular, a scheme of coating magnesium oxide, which is a material with a high secondary electron emission coefficient, on the phosphor layer of the lower panel of a PDP, can be preferably applied. FIGS. 13a and 13b illustrate the measurement and comparison results of the operational voltage margins of drive voltages obtained when the driving waveform of the present invention is applied to a typical panel without this consideration and a panel on which a magnesium oxide thin film is coated thin on a phosphor layer, respectively. Referring to FIG. 13b, it can be observed that the differences between R, G and B color cells are greatly improved compared to the typical panel, thus increasing the operational voltage margin.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Therefore, the present invention is not limited to the above embodiments and drawings, but should be appreciated to include scopes equivalent to claims, which will be described later, as well as the claims.

As described above, the present invention provides a method of driving an AC-type plasma display panel and plasma display apparatus, which shortens the time taken to transition to an address operation after the termination of an erase operation through the driving method and apparatus, so that the present invention is profitable for high-speed driving, and which minimizes the time taken to transition from the address operation to a sustain discharge, so that the present invention can perform a stable transition from an address discharge to a sustain discharge. Further, the present invention is advantageous in that, since sustain periods are not concentrated on a specific period, but uniformly distributed in one TV field, the power consumption is not concentrated on a specific period to facilitate the design of a power circuit, and the degradation of phosphor and the degradation of an image quality, such as an afterimage, due to an increase in the temperature of a panel contributable to a continuous sustain discharge can be prevented. Further, the present invention is advantageous in that a sub-field corresponding to a bit lower than that corresponding to one bit is easily implemented, thus further improving an ability to display low gray scales. Moreover, the present invention is advantageous in that, from the aspect of pseudo contour noise, the arrangement sequence of sub-fields can be freely changed according to scan lines, thus easily reducing the pseudo contour noise and simply implementing a high-quality image.

1. A method of driving an Alternating Current (AC)-type plasma display panel to display predetermined image information on the plasma display panel having a plurality of scan electrodes, a plurality of sustain electrodes corresponding to the scan electrodes, a plurality of address electrodes arranged to be orthogonal with the scan electrodes, and a plurality of discharge cells formed on respective locations where the scan electrodes and the address electrodes are orthogonal with each other, the image information having one or more frames each divided into one or more sub-fields used to display gray scales through combinations of the sub-fields, the sub-fields each being divided into one or more driving units T each having an address period, a sustain period and an erase period that are temporally separated, comprising:
writing data for a corresponding sub-field during an address period in a first one of the driving units T constituting the sub-field; and
erasing data for the corresponding sub-field during an erase period in a last one of the driving units T constituting the sub-field.

2. The plasma display panel driving method according to claim 1, wherein the scan electrodes are constructed so that a start point of one sub-field of one scan electrode is different from those of corresponding sub-fields of one or more adjacent scan electrodes.

3. The plasma display panel driving method according to claim 2, wherein the scan electrodes are constructed so that a start time of an m-th sub-field of an n-th scan electrode of the panel has a time difference of one driving unit T with respect to a start time of an m-th sub-field of an n+1-th scan electrode.

4. The plasma display panel driving method according to claim 1, wherein:
the address period of each of the driving units T is defined by a period equal to or longer than a time obtained by multiplying the total number of sub-fields by a width of a unit address pulse;
the sustain period is constructed in such a way that sustain pulses are alternatively applied to the scan and sustain electrodes during the sustain period; and
the erase period is constructed in such a way that a certain waveform to generate an erase discharge is applied to the scan electrodes during the erase period.

5. The plasma display panel driving method according to claim 4, wherein the waveform applied to the scan electrodes for an erase discharge has one or more periods during which multiple narrow pulses are repeated.

6. A method of driving an Alternating Current (AC)-type plasma display panel to display predetermined image information on the plasma display panel having a plurality of scan electrodes, a plurality of sustain electrodes corresponding to the scan electrodes, a plurality of address electrodes arranged to be orthogonal with the scan electrodes, and a plurality of discharge cells formed on respective locations where the scan electrodes and the address electrodes are orthogonal with each other, wherein:
the image information has one or more frames each divided into one or more driving units T, the driving units each having an address period, a sustain period and an erase period that are temporally separated; and
the erase period is constructed in such a way that a certain waveform to generate an erase discharge is applied to the scan electrodes during the erase period, the waveform having one or more periods during which multiple narrow pulses are repeated.

7. The plasma display panel driving method according to claim 5, wherein the narrow pulses each have a width of 300 ns or below.

8. The plasma display panel driving method according to claim 5, wherein the waveform applied to the scan electrodes for an erase discharge is formed so that a period during which a pulse having a negative polarity is applied is additionally inserted into periods during which multiple narrow pulses are repeated.

9. The plasma display panel driving method according to claim 5, wherein the multiple narrow pulses are overlapped with a ramp waveform increasing with the elapse of time and applied.

10. The plasma display panel driving method according to claim 6, wherein the narrow pulses each have a width of 300 ns or below.

11. The plasma display panel driving method according to claim 6, wherein the waveform applied to the scan electrodes for an erase discharge is formed so that a period during which a pulse having a negative polarity is applied is additionally inserted into periods during which multiple narrow pulses are repeated.

12. The plasma display panel driving method according to claim 6, wherein the multiple narrow pulses are overlapped with a ramp waveform increasing with the elapse of time and applied.

13. The plasma display panel driving method according to claim 1, wherein the sustain period of each of the driving units T constituting the sub-field is constructed so that one or more second address periods are additionally inserted into the sustain period so as to display a gray scale lower than a gray scale that can be displayed by a sub-field having a minimum time length.

14. The plasma display panel driving method according to claim 1, wherein the sub-fields constituting one frame are arranged in different sequences according to the scan lines.

15. An Alternating Current (AC)-type plasma display apparatus to display predetermined image information on an AC-type plasma display panel having a plurality of scan electrodes, a plurality of sustain electrodes corresponding to the scan electrodes, a plurality of address electrodes arranged to be orthogonal with the scan electrodes, and a plurality of discharge cells formed on respective locations where the scan electrodes and the address electrodes are orthogonal with each other, the image information having one or more frames each divided into one or more sub-fields used to display gray scales through combinations of the sub-fields, the sub-fields each being divided into one or more driving units T each having an address period, a sustain period and an erase period that are temporally separated, comprising:
driving means writing data for a corresponding sub-field during an address period in a first one of the driving units T constituting the sub-field; and
driving means erasing data for the corresponding sub-field during an erase period in a last one of the driving units T constituting the sub-field.
